(19) United States
(12) Patent Application Publication
(10) Pub. No.: US 2026/0320211 A1
(43) Pub. Date: Oct. 15, 2026

(54) APPROACHES FOR SECURING DATABASE MANAGEMENT OPERATIONS

(71) Applicant: Salesforce, Inc., San Francisco, CA (US)

(72) Inventor: Jyothi Babu Balaka, San Francisco, CA (US)

(21) Appl. No.: 19/174,416

(22) Filed: Apr. 9, 2025

(51) Int. Cl. G06F 21/62; G06F 21/60

(52) U.S. Cl. CPC G06F 21/6218; G06F 21/604

(57) ABSTRACT

Methods and corresponding systems and apparatuses for securing database management operations are described. A request to propagate a database management operation through a first containerized database instance to one or more different containerized database instances may be determined. A determination may be made that the request satisfies at least one access control restriction to perform the database management operation. A determination may be made that the request to perform the database management operation is permitted to be propagated to the second containerized database instance based at least in part on a network scope configured for the first containerized database instance. The database management operation may be provided to the first containerized database instance for execution and propagated for execution on at least the second containerized database instance.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to securing database management operations for cloud-based services and infrastructure.

### BACKGROUND

Modern distributed databases in multi-tenant cloud architectures may face serious risks when manually executing database management operations through centralized management systems. For example, routine maintenance tasks, such as schema updates and performance tuning, may lead to catastrophic outages affecting large portions of the infrastructure when executed improperly. Further, manual database management operations conducted through jump boxes may create significant security vulnerabilities and increase the potential for system-wide failures. The distributed nature of modern databases across multiple regions may amplify the impact of database operational errors.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to implementations by one skilled in the art without departing from the spirit and scope of the disclosure.

FIG. 1 shows a block diagram of an example computing environment, according to some embodiments.

FIG. 2 shows an example containerized environment with containerized database instances, according to some embodiments.

FIG. 3 shows a flow diagram of an example process for creating and managing containers, according to some embodiments.

FIG. 4 shows a flow diagram of an example process for controlling user access to containerized database instances based on role and operational scope, according to some embodiments.

FIG. 5 shows a flow diagram of an example process for controlling user access to containerized database instances based on just-in-time access controls, according to some embodiments.

FIG. 6 shows an example application of approaches for securing database management operations, according to some embodiments.

FIG. 7 shows a flow diagram of an example process, according to some embodiments.

FIG. 8A shows a system diagram illustrating architectural components of an applicable environment, in accordance with some implementations.

FIG. 8B shows a system diagram further illustrating architectural components of an applicable environment, in accordance with some implementations.

FIG. 9 shows a system diagram illustrating the architecture of a multi-tenant database environment, in accordance with some implementations.

FIG. 10 shows a system diagram further illustrating the architecture of a multi-tenant database environment, in accordance with some implementations.

### DETAILED DESCRIPTION

Examples of systems and methods are described herein with reference to certain implementations. These examples are being provided solely to add context and aid in the understanding of the present disclosure. It will thus be apparent to one skilled in the art that the techniques described herein may be practiced without some or all of these specific details. In other instances, well-known process operations have not been described in detail in order to avoid unnecessarily obscuring the present disclosure. Other applications are possible, such that the following examples should not be taken as definitive or limiting either in scope or setting.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having a computer-readable program code embodied therein.

Modern distributed databases operating across multiple cloud regions face a critical vulnerability in their operational management approach. The current practice of executing changes (or operations) manually through centralized management hosts creates a significant point of failure that can have far-reaching consequences across the entire database ecosystem. When database administrators implement operational changes, such as schema updates or performance tuning, through direct host-level logins, they operate without adequate safeguards. These direct access methods typically lack proper scope limitation, governance controls, and oversight mechanisms, creating an environment where a single operational error can cascade into system-wide failures. The centralized nature of database management systems inherently concentrates risk, as problems with a single component can trigger a chain reaction, leading to a complete system shutdown. Accordingly, distributed databases remain vulnerable to both unintentional errors and malicious attacks. The disconnection between database administrators and domain-specific application knowledge may further compound these risks, as those making changes may not fully understand the impact of database management operations being performed.

Embodiments described herein provide a claimed solution that is necessarily rooted in computer technology (e.g., computer networks). The claimed solution addresses these challenges using a multi-faceted access management system for regulating operations performed on database management systems. The access management system may employ one or a combination of approaches to limit access to and from database management systems, thereby helping limit the blast radius of operations. A blast radius may refer to the potential impact or extent of damage that a failure or security breach can have within database management systems. The blast radius may measure how far the effects of an incident, such as a database error or unauthorized access, can propagate and affect other systems or users.

According to some embodiments, the access management system may employ scoped isolation using containers. In such embodiments, a database instance may be configured to run in a container. As an example, the database instance may be containerized using Docker (developed by Docker, Inc., available at https://www.docker.com/). The container may be configured to restrict access to and from the containerized database instance, as well as corresponding resources and databases, based on network scope. That is, access to the containerized database instance may be restricted to authorized infrastructure units (e.g., hosts, pods, super pods, etc.). Similarly, access from the containerized database instance may also be restricted to authorized infrastructure units. In some embodiments, the access management system may also implement role-based access controls (RBAC) to limit certain operations to authorized users. For example, users may be assigned roles (e.g., administrator, operator, viewer, etc.). In this example, a user is required to be associated with the requisite role and operational scope before being permitted to execute an operation on the containerized database instance. In some embodiments, the access management system may also implement just-in-time (JIT) access control. For example, the JIT access control may be implemented to permit execution of certain operations in incident response scenarios, provided that one or more conditions are satisfied. For example, a condition may include executing the operation during an approved time window. In another example, a condition may include satisfying an operations approval workflow before executing an operation.

The claimed solution provides a number of advantages over conventional approaches. That is, the access management system combines various approaches for securing database management operations to enhance security and limit blast radius. For instance, scoped isolation using containers may help limit the blast radius of various operations by enforcing network and resource isolation. Further, role-based access control may help align user access with predefined roles, thereby helping reduce outages that may result from unauthorized user actions. Moreover, just-in-time access may further minimize exposure by granting temporary, context-specific privileges (e.g., time-bound database admin rights, operations workflow approval, etc.). Additional details and related advantages are provided herein.

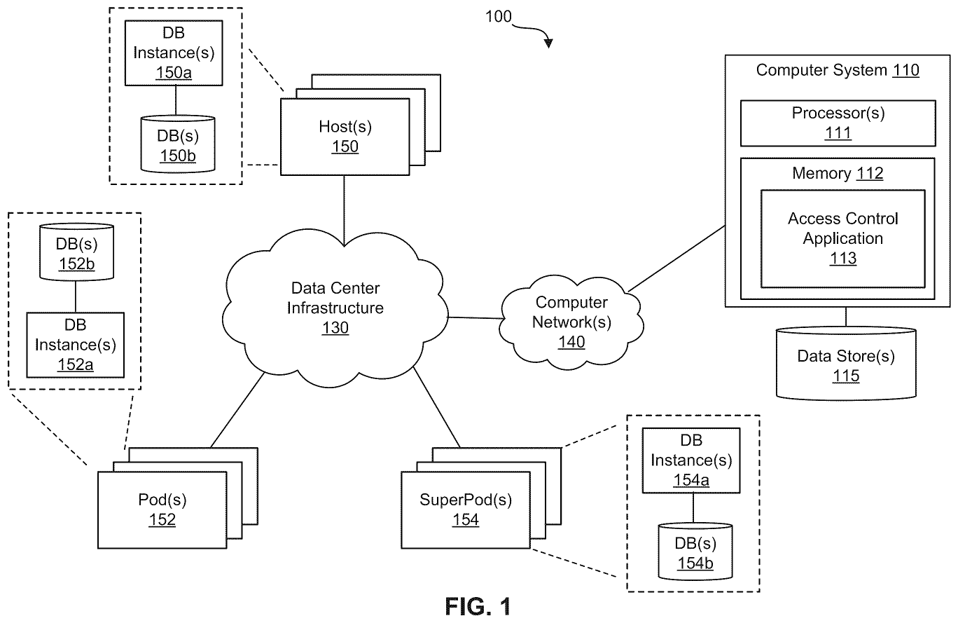

FIG. 1 shows a block diagram of an example computing environment 100 incorporating one or more implementations. The computing environment 100 includes a computer system 110 and data center infrastructure 130, which may communicate through one or more computer networks 140 (e.g., the Internet). The computer network(s) 140 may include one or more wireless networks, one or more wired networks, or a combination of wired and wireless networks. For example, the computer network 140 may be any one or any combination of one or more LANs (local area networks), WANs (wide area networks), telephone networks, and wireless networks, among others.

The computer system 110 may include one or more processors 111 and memory 112. The processor(s) 111 may include general-purpose processors, special-purpose processors, or combinations thereof. The memory 112 may include one or more memory devices comprising non-volatile storage, volatile storage, or a combination thereof. The computer system 110 may be configured to provide access to an access control application 113, for example, upon execution by the processor(s) 111. In various embodiments, the computer system 110 may implement a Software as a Service (SaaS) model, a Platform as a Service (PaaS) model, or any other cloud computing model to facilitate access to the access control application 113. The computer system 110 may be associated with one or more data stores 115, which may be accessible through wired or network-based connections. The access control application 113 may be configured to implement a multi-faceted operational strategy to limit the blast radius of database management operations performed on database management systems, as described herein. That is, the access control application 113 may be configured to limit this blast radius by implementing access control mechanisms that restrict who may or may not perform such operations, where such operations may or may not be performed, and when such operations may or may not be performed, or a combination thereof.

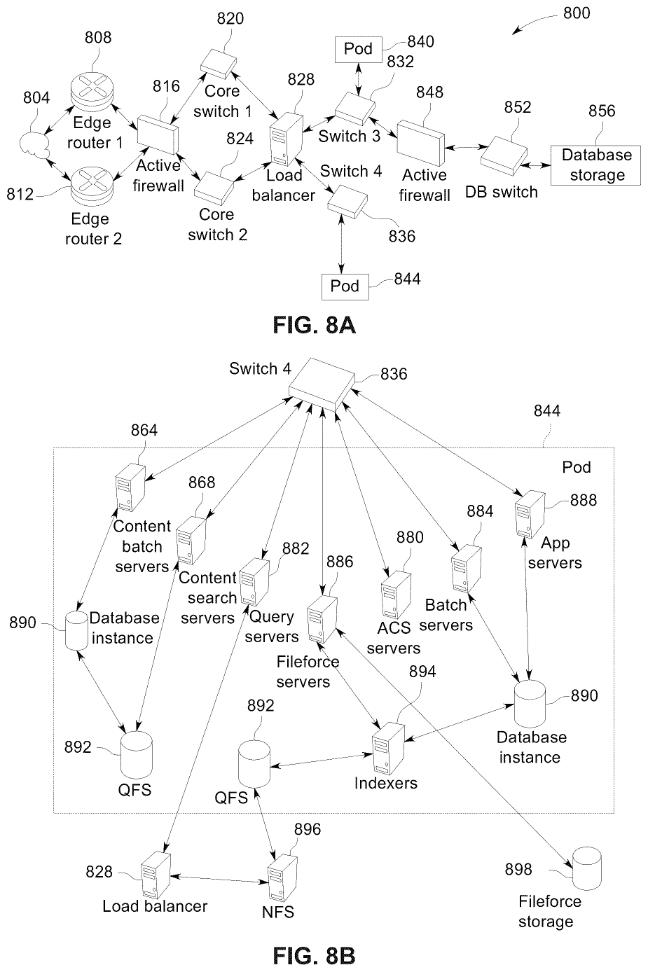

The data center infrastructure 130 may include various computing systems that operate together to provide various multi-tenant cloud-based services and infrastructure, and which may include various aspects of the architecture and environments described in reference to FIGS. 8A-8B, 9, and 10. As illustrated in FIG. 1, the data center infrastructure 130 may include infrastructure units, such as one or more hosts, pods, and super pods, representing different levels of infrastructure abstraction and resource allocation. For example, a host 150 may be a physical or virtual machine that provides compute resources. A host 150 may operate on a multi-tenant architecture implemented by the data center infrastructure 130, where multiple customers share the same underlying hardware, database, and application layers. A pod 152 may be a self-contained infrastructure unit that includes dedicated computing, networking, database, and storage resources allocated to support multiple tenants according to the multi-tenant architecture. A super pod 154 may refer to a specialized, dedicated hardware configuration that may also support multiple tenants according to the multi-tenant architecture. The super pod 154 may provide additional resources to address data segregation and privacy concerns. For instance, the super pod 154 may be configured to isolate a customer's instance on separate hardware within the data center infrastructure 130. For example, the super pod 154 may be used by larger organizations like financial institutions or government agencies.

Infrastructure units may provide database services to tenants of the multi-tenant architecture. In general, database services may be provided by database instances that run on infrastructure units. A database instance may refer to a self-contained environment that manages and provides access to a specific set of databases. The database instance may provide a runtime environment that allows users to interact with and manipulate the data stored in those databases. For example, as shown in FIG. 1, the host 150 may run one or more database (DB) instances 150a that manage and provide access to one or more databases (DBs) 150b, the pod 152 may run one or more database (DB) instances 152a that manage and provide access to one or more databases (DBs) 152b, and the super pod 154 may run one or more database (DB) instances 154a that manage and provide access to one or more databases (DBs) 154b.

As used herein, “database management operations” may encompass broader administrative tasks aimed at maintaining the overall health, security, and performance of database systems. These include activities, such as backup and recovery, performance monitoring, schema design, user access control, concurrency management, and auditing. As an example, database management operations may be performed by database administrators (DBAs) using specialized tools or software like Database Management Systems (DBMS).

When executing database management operations in a distributed database environment, database management operations performed on one database instance may also be executed on (or propagated to) other database instances. For example, when executing database management operations to implement a schema change, the schema may first be implemented on a primary database instance running on a primary infrastructure unit (e.g., pod 152), and then propagated to one or more replicated database instances running on one or more replicated infrastructure units (e.g., super pod 154), ensuring that all instances remain synchronized and ready for failover if needed. In another example, database management operations to implement performance tuning, such as optimizing queries or indexing, may be propagated from one database instance (e.g., host 150) to another (e.g., pod 152, super pod 154) to apply similar optimizations. Many variations are possible.

According to various embodiments, the access control application 113 may limit the blast radius of database management operations by implementing a number of access control mechanisms. The access control mechanisms may restrict who may or may not perform such operations, where such operations may or may not be performed, when such operations may or may not be performed, or a combination thereof.

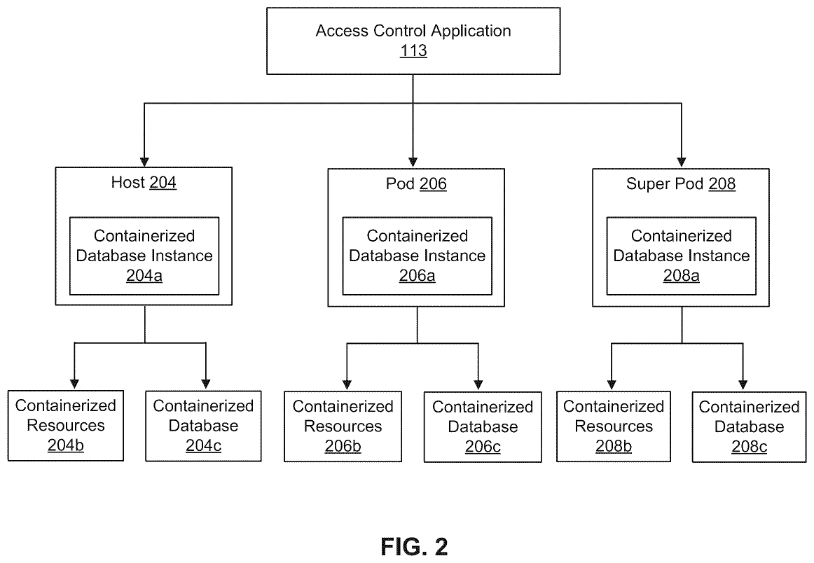

In some embodiments, the access control application 113 may limit the blast radius of database management operations by running database instances in a containerized environment with scoped isolation. In such embodiments, a database instance may be configured to run in a container. As an example, the database instance may be containerized using Docker (developed by Docker, Inc., available at https://www.docker.com/). For example, FIG. 2 illustrates an example containerized environment with containerized database instances, according to some embodiments. In the example of FIG. 2, a containerized database instance 204a is running on a host 204, which may interact with containerized resources 204b and one or more containerized databases 204c. Further, FIG. 2 shows a containerized database instance 206a running on a pod 206, which may interact with containerized resources 206b and one or more containerized databases 206c. In another example, FIG. 2 shows a containerized database instance 208a running on a super pod 208, which may interact with containerized resources 208b and one or more containerized databases 208c.

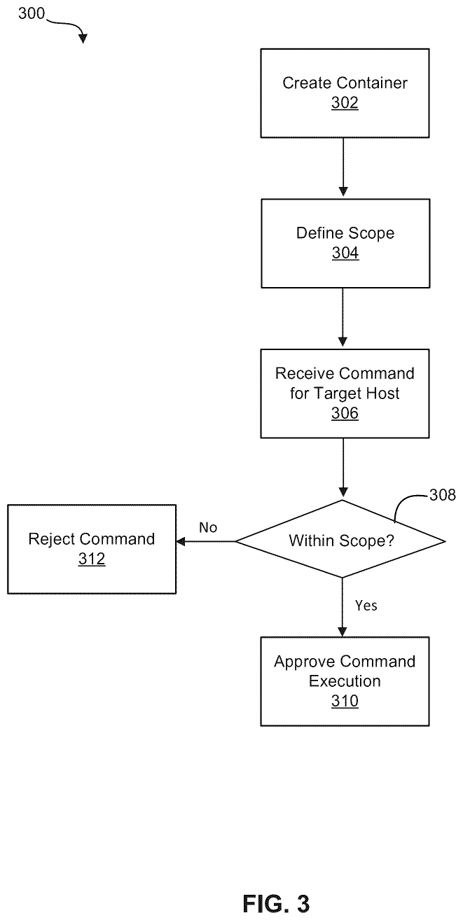

In various embodiments, the access control application 113 may create and manage containers corresponding to database instances of a database management system. For example, FIG. 3 shows a flow diagram of an example process for creating and managing containers, according to some embodiments.

At block 302, the access control application 113 may create a container for a database instance of a database management system. For example, the access control application 113 may create the container by calling Docker commands (e.g., “docker container create”) based on the following example pseudocode:

```
def create_dbmgt_container(super_pod_id):
  container = Container.create( name=f“dbmgt_{super_pod_id}”,
  network_scope=f“superpod_{super_pod_id}_network”,
  permissions=“read-write”,
  resources={“CPU”: “2 cores”, “Memory”: “4GB”}
)
return container.
```

Based on the example pseudocode, the access control application 113 may create a container (e.g., containerized database instance 208a) for a super pod (e.g., the super pod 208) identified by a “super_pod_id”. In this example, the container is associated with a network named “superpod_{super_pod_id}_network”. Further, in this example, the container is granted “read-write” permission, meaning the container may both read from and write to any associated resources (e.g., containerized resources 208b) and databases (e.g., containerized databases 208c). The container is also allocated a set of resources (e.g., a CPU with 2 cores and 4GB memory).

At block 304, the access control application 113 may define a network scope for the created container. The access control application 113 may restrict access to and from the container (e.g., containerized database instance 208a) based on the defined network scope. That is, access to and from the container (e.g., containerized database instance 208a) may be granted to authorized infrastructure units (e.g., hosts, pods, super pods, etc.) and denied to others. The access control application 113 may implement the following example pseudocode to configure the network scope:

```
def set_network_policies(container):
  container.restrict_network_access (
    allowed_hosts=[“host-1”, “pod-1”]
)
```

Based on the example pseudocode, the access control application 113 may restrict network communications to and from the container to authorized infrastructure units. In this example, network access to and from the container is restricted to the infrastructure units named “host-1” and “pod-1”. Accordingly, in this example, database management operations may be propagated from the container (e.g., containerized database instance 208a) running on the super pod (e.g., the super pod 208) to a container (e.g., containerized database instance 204a) running on host-1 (e.g., the host 204) and to a container (e.g., containerized database instance 206a) running on pod-1 (e.g., the pod 206), thereby limiting the blast radius of such operations to the containerized super pod, host, and pod.

At block 306, based on the defined network scope, the access control application 113 may enforce execution boundaries for any database management operations to be executed by a container. For example, the access control application 113 may implement the following example pseudocode to enforce execution boundaries:

```
def execute_dbmgt_operations(container, command):
  if container.is_within_scope(command.target_host):
    result = container.execute_command(command)
    return result
  else:
    raise PermissionError(“Command target is outside allowed scope.”)
```

Based on the example pseudocode, the access control application 113 may be provided information (or parameters) identifying a container and a database management operation (or “command”) to be performed on (or propagated to) a target host (e.g., “target_host”) through the container. For example, a user (e.g., database administrator) interacting with the access control application 113 may provide the information identifying the container and the database management operation.

At block 308, the access control application 113 may determine whether the database management operation targets infrastructure units within the network scope defined for the container. If a determination is made that the database management operation is intended for execution on a target host within the network scope, the process 300 may proceed to block 310. At block 310, the access control application 113 may execute the database management operation or, in some embodiments, provide the database management operation for execution to the target host. According to some embodiments, the execution of the database management operation may depend on satisfaction of one or more additional approaches for securing database management operations, as described herein. If a determination is made that the database management operation is intended for execution on a target host outside of the network scope, the process 300 may proceed to block 312. At block 312, the access control application 113 may throw an error and prevent the database management operation from executing.

In the foregoing example, if a database administrator attempts to run a schema update on host-1 and/or pod-1, the access control application 113 may allow such commands since both host-1 and pod-1 are within the network scope defined for the container. However, if the database administrator attempts to run the schema update on a pod named “pod-5”, the access control application 113 may prevent the schema update on pod-5 and throw an error, preventing the schema update from executing. As a result, the containerized environment helps prevent errors resulting from database management operations from cascading across infrastructure units outside of the defined network scope.

According to some embodiments, another approach for securing database management operations involves implementing a role-based access controls (RBAC) framework. The role-based access controls may establish a structured security framework that restricts database management operations according to a user's assigned role (e.g., administrator, operator, viewer) and operational scope (e.g., one or more hosts, pods, and/or super pods). This framework ensures that access to containerized database instances may be limited by user role and authorized operational scope, thus creating a layered defense to limit the blast radius of database management operations.

In various embodiments, the access control application 113 may implement the RBAC architecture with three primary roles with distinct permission levels: administrator, operator, and viewer. For example, a user with an “administrator” role may possess comprehensive privileges, allowing the user to perform all database management operations, including configuration changes, user management, and critical system modifications. In another example, a user with an “operator” role may have intermediate access rights, enabling the user to execute routine maintenance tasks, monitor performance, and handle operational workflows, but the user may not be permitted to make fundamental system changes. In another example, a “viewer” role may have the most restricted access, limited to monitoring and observing database activities without the ability to modify configurations or data.

Additionally, each user may be associated with an operational scope that further refines access permissions. For example, a user may be assigned to a host-level operational scope, a pod-level operational scope, or a super pod-level operational scope. At the host-level operational scope, user interaction may be restricted to infrastructure units corresponding to a host type (e.g., the host 204). At the pod-level operational scope, user interaction may be restricted to infrastructure units corresponding to a pod type (e.g., the pod 206). At the pod-level operational scope, user interaction may be restricted to infrastructure units corresponding to a super pod type (e.g., the super pod 208). This hierarchical structure ensures that users may only perform actions appropriate to both their role and their assigned operational scope.

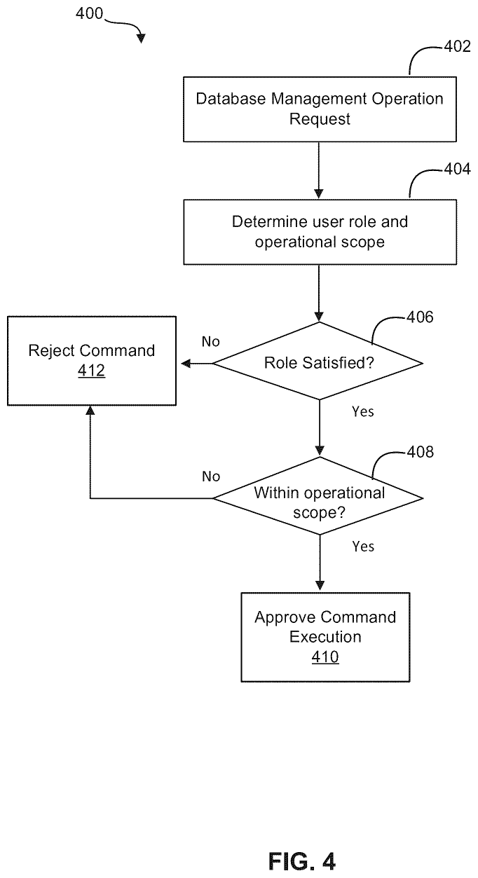

For example, FIG. 4 shows a flow diagram of an example process for controlling user access to containerized database instances based on role and operational scope, according to some embodiments.

At block 402, the access control application 113 may receive a request to execute a database management operation. The request may be submitted by a user. At block 404, the access control application 113 may determine a role and operational scope associated with the user that submitted the request.

At block 406, the access control application 113 may determine whether the role associated with the user satisfies pre-defined rules for executing the database management operation identified by the request. For example, the pre-defined rules may be created to grant appropriate levels of access to administrators, operators, and viewers based on organizational responsibilities and security requirements. If a determination is made that the role associated with the user does not satisfy the pre-defined rules for executing the database management operation, the process 400 may proceed to block 412. At block 412, the access control application 113 may throw an error and prevent the database management operation from executing. If a determination is made that the role associated with the user satisfies the pre-defined rules for executing the database management operation, the process 400 may proceed to block 408.

At block 408, the access control application 113 may determine whether the operational scope associated with the user satisfies the pre-defined rules for executing the database management operation. If a determination is made that the operational scope associated with the user does not satisfy the pre-defined rules for executing the database management operation, the process 400 may proceed to block 412. At block 412, the access control application 113 may throw an error and prevent the database management operation from executing. If a determination is made that the operational scope associated with the user satisfies the pre-defined rules for executing the database management operation, the process 400 may proceed to block 410.

At block 410, the access control application 113 may execute the database management operation or, in some embodiments, provide the database management operation for execution. According to some embodiments, the execution of the database management operation may depend on the satisfaction of one or more additional approaches for securing database management operations, as described herein.

According to some embodiments, another approach for securing database management operations involves the implementation of a just-in-time (JIT) access controls. The JIT access controls may be implemented to provide users with temporary, scoped access to critical systems or resources while maintaining strict security and accountability.

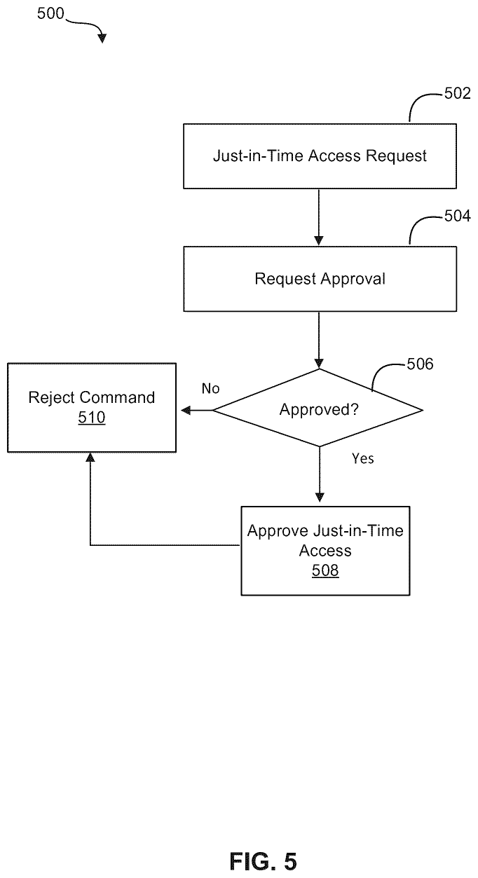

For example, FIG. 5 shows a flow diagram of an example process for controlling user access to containerized database instances based on just-in-time (JIT) access controls, according to some embodiments.

At block 502, the access control application 113 may determine that a user submitted a JIT request. The JIT request may identify the user submitting the JIT request, a task scope, and duration needed to complete a database management operation. For example, the user may request temporary access to a specific system or resource they need to work on. The user specify what they need access to (the task scope) and for how long (the duration).

At block 504, the JIT request may be reviewed through an operations approval workflow where someone, such as a manager or an automated system, validates the necessity and scope of the JIT request against organizational policies and operational requirements and either approves or denies the JIT request.

At block 506, a determination is made whether the JIT request was approved or denied. If the JIT request is approved, the method 500 may proceed block 508. At block 508, the access control application 113 may execute the database management operation or, in some embodiments, allow the user to execute the database management operation based on the scope and duration identified in the JIT request. According to some embodiments, the execution of the database management operation may depend on the satisfaction of one or more additional approaches for securing database management operations, as described herein. Once the user starts working with their temporary access, the access control application 113 may begin tracking everything they do. The access control application 113 may keep detailed logs of their actions—like commands they run or changes they make—and these logs may be reviewed in real-time. If anything unusual or unauthorized happens, it can be flagged immediately for further investigation. These logs also provide a record of what happened during the session, which can be useful for audits or troubleshooting later. Alternatively, if the JIT request is denied, the method 500 may proceed block 510. At block 510, the access control application 113 may throw an error and prevent the JIT request from executing.

According to some embodiments, another approach for securing database management operations involves a blast radius containment policy. In some embodiments, the access control application 113 may limit the execution of database management operations to a single pod or super pod based on the blast radius containment policy. In such embodiments, direct operations on multi-region resources (or infrastructure units) may be disabled unless explicitly approved, for example, through an operations approval workflow. In some embodiments, based on the blast radius containment policy, the access control application 113 may segment networks to isolate each super pod into its own logical security domain, thereby preventing interference across infrastructure units. In some embodiments, based on the blast radius containment policy, the access control application 113 may implement restricted execution environments on a per-pod basis to further contain the blast radius.

According to some embodiments, another approach for securing database management operations involves satisfying an operations approval workflow. For example, before a database management operation may be executed, a request for executing the database management operation may be provided to the operations approval workflow. The operations approval workflow may help ensure that critical actions are properly vetted and authorized before execution, often requiring hierarchical levels of supervisory approval to align with organizational policies and risk management protocols. The operations approval workflow may involve a structured sequence where a user initiates a request for executing a database management operation and the request is routed to designated approvers based on predefined roles and authority levels. For example, a junior employee may submit a request that first requires approval from their direct supervisor. If the request is approved, the access control application 113 may execute the database management operation or, in some embodiments, allow the user to execute the database management operation. According to some embodiments, the execution of the database management operation may depend on the satisfaction of one or more additional approaches for securing database management operations, as described herein.

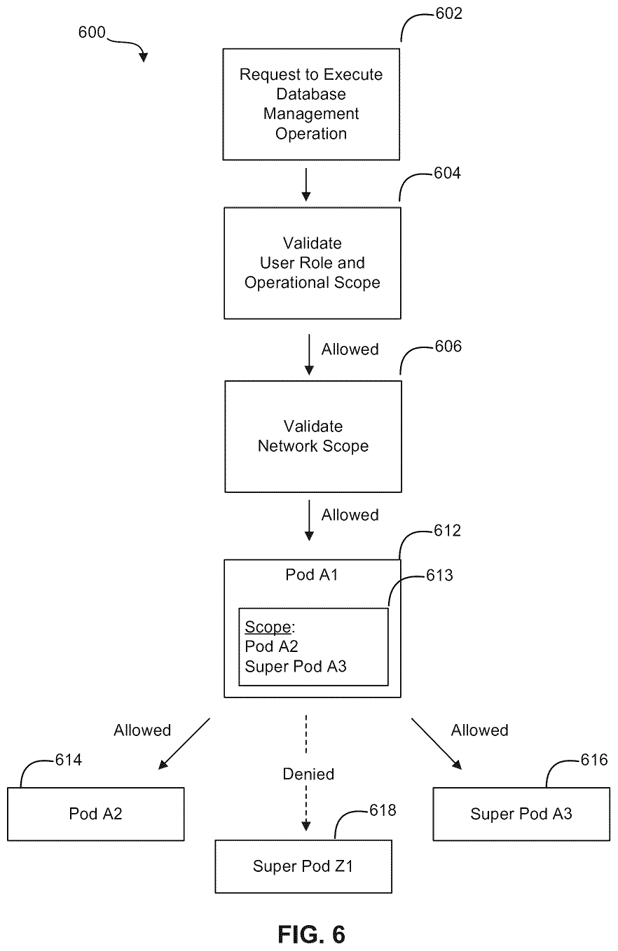

FIG. 6 shows an example application of some approaches for securing database management operations, according to some embodiments.

In the example application 600 of FIG. 6, at block 602, a user may submit a request to execute one or more database management operations across a number of infrastructure units. For example, the request may specify a schema update operation to be performed on pod A1 612, and propagated to pod A2 614, super pod A3 616, and super pod Z1 618.

At block 604, the access control application 113 may evaluate the request, for example, based on a role and operational scope associated with the user, as described above in reference to FIG. 4. In this example, the access control application 113 may determine that the user associated with the request has an “administrator” role and an operational scope that permits access to pods and super pods. Accordingly, the access control application 113 may determine the request satisfies the role and operational scope requirements needed to execute the request.

At block 606, the access control application 113 may evaluate a network scope needed to perform the request. In this example, the request seeks to execute schema updates to the pod A1 612, the pod A2 614, the super pod A3 616, and the super pod Z1 618. In this example, the access control application 113 may determine that a network scope 613 associated with the pod A1 permits propagation of database management operations to the pod A2 614 and the super pod A3 616. Based on this network scope 613, the access control application 113 may allow the requested schema update operation to be performed on the pod A2 614 and the super pod A3 616, but deny the requested schema update operation on the super pod Z1 618, since the super pod Z1 618 is outside of the network scope 613.

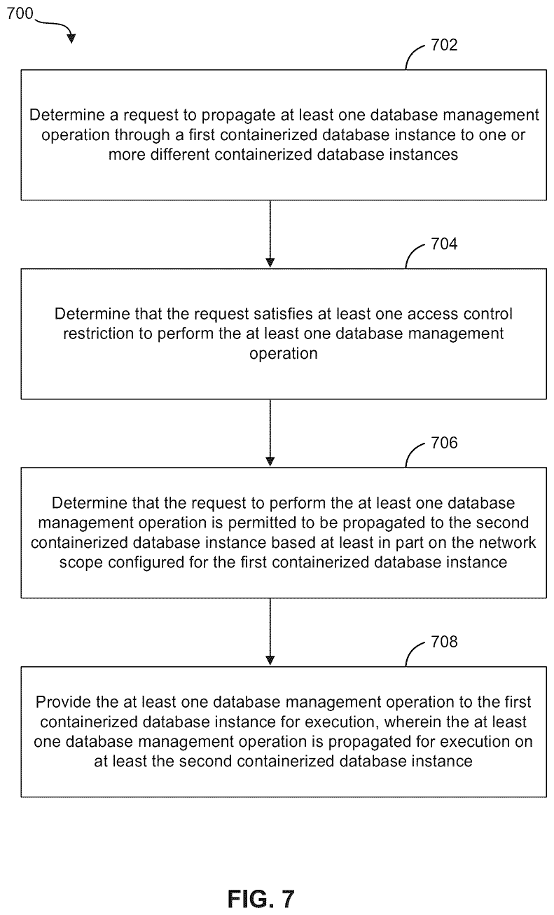

FIG. 7 shows a flow diagram of an example process 700, according to some embodiments. The process 700 can be performed by one or more processors of a computer system, such as the computer system 110 of FIG. 1.

At block 702, the computer system may determine a request to propagate at least one database management operation through a first containerized database instance to one or more different containerized database instances. A network scope of the first containerized database instance may be configured to allow database management operations to be propagated to at least a second containerized database instance.

At block 704, the computer system may determine that the request satisfies at least one access control restriction to perform the at least one database management operation.

At block 706, the computer system may determine that the request to perform the at least one database management operation is permitted to be propagated to the second containerized database instance based at least in part on the network scope configured for the first containerized database instance.

At block 708, in response to determining that (i) the request satisfies the at least one access control restriction to perform the at least one database management operation and (ii) that the request to propagate the at least one database management operation through the first containerized database instance to the second containerized database instance is permitted, the computer system may provide the at least one database management operation to the first containerized database instance for execution, wherein the at least one database management operation is propagated for execution on at least the second containerized database instance.

FIG. 8A shows a system diagram illustrating architectural components of an on-demand service environment 800, in accordance with some implementations. For instance, the on-demand service environment 800 may correspond to an implementation of computing environment 100 in FIG. 1. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as pods 840 and 844. The pods 840 and 844, which may each include one or more servers and/or other computing resources, may perform data processing and other operations used to provide on-demand services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some implementations of an on-demand service environment may include anywhere from one to many devices of each type. Also, the on-demand service environment need not include each device shown in FIGS. 8A and 8B or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some implementations, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more implementations, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some implementations, the core switches 820 and 824 are high-capacity switches that transfer packets within the on-demand service environment 800. The core switches 820 and 824 may be configured as network bridges that quickly route data between different components within the on-demand service environment. In some implementations, the use of two or more core switches 820 and 824 may provide redundancy and/or reduced latency.

In some implementations, the pods 840 and 844 may perform the core data processing and service functions provided by the on-demand service environment. Each pod may include various types of hardware and/or software computing resources. An example of the pod architecture is discussed in greater detail with reference to FIG. 8B.

In some implementations, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some implementations, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some implementations, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

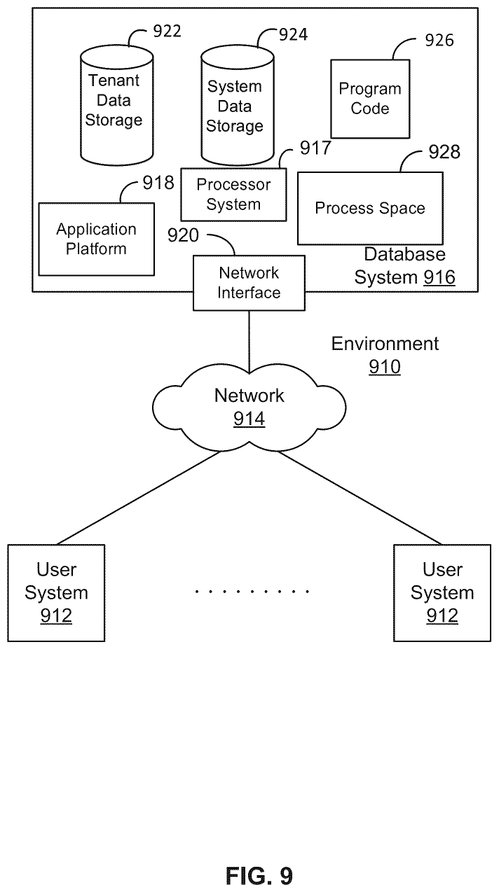

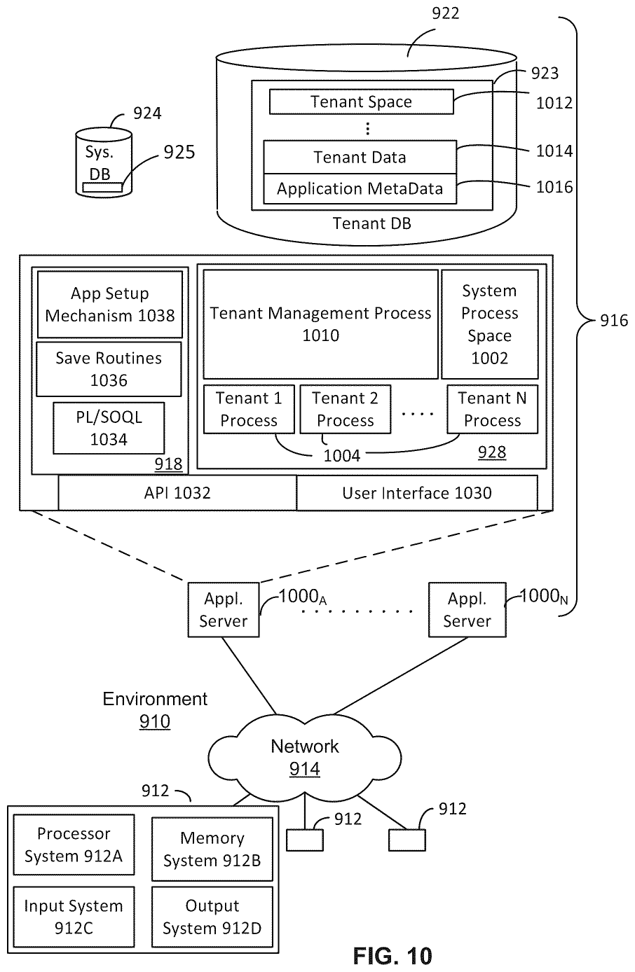

In some implementations, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some implementations, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one implementation. The pod 844 may be used to render services to a user of the on-demand service environment 800. In some implementations, each pod may include a variety of servers and/or other systems. The pod 844 includes one or more content batch servers 864, content search servers 868, query servers 882, Fileforce servers 886, access control system (ACS) servers 880, batch servers 884, and app servers 888. Also, the pod 844 includes database instances 890, quick file systems (QFS) 892, and indexers 894. In one or more implementations, some or all communication between the servers in the pod 844 may be transmitted via the switch 836.

In some implementations, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may handle requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 886 may manage requests for information stored in the Fileforce storage 898. The Fileforce storage 898 may store information such as documents, images, and basic large objects (BLOBs). By managing requests for information using the Fileforce servers 886, the image footprint on the database may be reduced.

The query servers 882 may be used to retrieve information from one or more file systems. For example, the query servers 882 may receive requests for information from the app servers 888 and then transmit information queries to network file systems (NFS) 896 located outside the pod. The pod 844 may share a database instance 890 configured as a multi-tenant environment in which different organizations share access to the same database. Additionally, services rendered by the pod 844 may require various hardware and/or software resources. In some implementations, the ACS servers 880 may control access to data, hardware resources, or software resources.

In some implementations, the batch servers 884 may process batch jobs, which are used to run tasks at specified times. Thus, the batch servers 884 may transmit instructions to other servers, such as the app servers 888, to trigger the batch jobs. For some implementations, the QFS 892 may be an open source file system available from Sun Microsystems® of Santa Clara, California. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the NFS 896 and/or other storage systems.

In some implementations, one or more query servers 882 may communicate with the NFS 896 to retrieve and/or update information stored outside of the pod 844. The NFS 896 may allow servers located in the pod 844 to access information to access files over a network in a manner similar to how local storage is accessed. In some implementations, queries from the query servers 882 may be transmitted to the NFS 896 via the load balancer 828, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some implementations, the pod may include one or more database instances 890. The database instance 890 may transmit information to the QFS 892. When information is transmitted to the QFS, it may be available for use by servers within the pod 844 without requiring an additional database call. In some implementations, database information may be transmitted to the indexer 894. Indexer 894 may provide an index of information available in the database 890 and/or QFS 892. The index information may be provided to Fileforce servers 886 and/or the QFS 892.

FIG. 9 shows a block diagram of an environment 910 wherein an on-demand database service might be used, in accordance with some implementations. Environment 910 includes an on-demand database service 916. User system 912 may be any machine or system that is used by a user to access a database user system. For example, any of user systems 912 can be a handheld computing system, a mobile phone, a laptop computer, a workstation, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In some implementations, system 916, shown in FIG. 9, implements a web-based customer relationship management (CRM) system. For example, in some implementations, system 916 includes application servers configured to implement and execute CRM software applications as well as provide related data, code, forms, webpages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain implementations, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 916 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 916 is configured to provide webpages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some implementations. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 1000A-1000N, system process space 1002, tenant process spaces 1004, tenant management process space 1010, tenant storage area 1012, user storage 1014, and application metadata 1016. In other implementations, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers' creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 1034 that provides a programming language style interface extension to API 1032. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 1000 might be coupled via the network 914 (e.g., the Internet), another application server 1000 might be coupled via a direct network link, and another application server 1000 might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain implementations, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some implementations, therefore, an interface system implementing a load balancing function (e.g., an F5 Big-IP load balancer) is communicably coupled between the application servers 1000 and the user systems 912 to distribute requests to the application servers 1000. In some implementations, the load balancer uses a least connections algorithm to route user requests to the application servers 1000. Other examples of load balancing algorithms, such as round robin and observed response time, also can be used. For example, in certain implementations, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain implementations, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

In this description, the term “application” refers to computational logic for providing the specified functionality. An application can be implemented in hardware, firmware, and/or software. Where the applications described herein are implemented as software, the application can be implemented as a standalone program, but can also be implemented through other means, for example as part of a larger program, as any number of separate programs, or as one or more statically or dynamically linked libraries. It will be understood that the named applications described herein represent one embodiment, and other embodiments may include other applications. In addition, other embodiments may lack applications described herein and/or distribute the described functionality among the applications in a different manner. Additionally, the functionalities attributed to more than one application can be incorporated into a single application. In an embodiment where the applications as implemented by software, they are stored on a computer readable persistent storage device (e.g., hard disk), loaded into the memory, and executed by one or more processors. Alternatively, hardware or software applications may be stored elsewhere within a computing system.

As referenced herein, a computer or computing system includes hardware elements used for the operations described here, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
determining, by a computing system, a request to propagate at least one database management operation through a first containerized database instance to one or more different containerized database instances, wherein a network scope of the first containerized database instance is configured to allow database management operations to be propagated to at least a second containerized database instance;
determining, by the computing system, that the request satisfies at least one access control restriction to perform the at least one database management operation;
determining, by the computing system, that the request to perform the at least one database management operation is permitted to be propagated to the second containerized database instance based at least in part on the network scope configured for the first containerized database instance; and
in response to determining that (i) the request satisfies the at least one access control restriction to perform the at least one database management operation and (ii) that the request to propagate the at least one database management operation through the first containerized database instance to the second containerized database instance is permitted, providing, by the computing system, the at least one database management operation to the first containerized database instance for execution, wherein the at least one database management operation is propagated for execution on at least the second containerized database instance.

2. The computer-implemented method of claim 1, wherein determining that the request satisfies at least one access control restriction comprises:
determining that a user that provided the request is associated with a role and operational scope required to execute the at least one database management operation.

3. The computer-implemented method of claim 2, wherein the role identifies the user as an administrator, an operator, or a viewer.

4. The computer-implemented method of claim 2, wherein the operational scope identifies at least one type of infrastructure unit that is accessible to the user.

5. The computer-implemented method of claim 4, wherein the type of infrastructure unit corresponds to a host, pod, or super pod.

6. The computer-implemented method of claim 1, wherein determining that the request satisfies at least one access control restriction comprises:
determining that the request is approved as a just-in-time request that allows execution of the at least one database management operation during an approved time window.

7. The computer-implemented method of claim 1, wherein determining that the request satisfies at least one access control restriction comprises:
determining that the request is approved by an operations approval workflow.

8. The computer-implemented method of claim 1, wherein the first containerized database instance is running on a first infrastructure unit, and wherein the second containerized database instance is running on a second infrastructure unit.

9. The computer-implemented method of claim 1, wherein a third containerized database instance is outside of the network scope associated with the first containerized database instance, and wherein propagation of the at least one database management operation to the third containerized database instance is denied.

10. The computer-implemented method of claim 1, wherein the at least one database management operation involves at least one of the following operations: backup and recovery, performance monitoring, schema design, user access control, concurrency management, or auditing.

11. A computer system comprising:
one or more processors; and
memory storing instructions that, when executed, cause the one or more processors to perform:
determining a request to propagate at least one database management operation through a first containerized database instance to one or more different containerized database instances, wherein a network scope of the first containerized database instance is configured to allow database management operations to be propagated to at least a second containerized database instance;
determining that the request satisfies at least one access control restriction to perform the at least one database management operation;
determining that the request to perform the at least one database management operation is permitted to be propagated to the second containerized database instance based at least in part on the network scope configured for the first containerized database instance; and
in response to determining that (i) the request satisfies the at least one access control restriction to perform the at least one database management operation and (ii) that the request to propagate the at least one database management operation through the first containerized database instance to the second containerized database instance is permitted, providing the at least one database management operation to the first containerized database instance for execution, wherein the at least one database management operation is propagated for execution on at least the second containerized database instance.

12. The computer system of claim 11, wherein determining that the request satisfies at least one access control restriction causes the one or more processors to perform:
determining that a user that provided the request is associated with a role and operational scope required to execute the at least one database management operation.

13. The computer system of claim 12, wherein the role identifies the user as an administrator, an operator, or a viewer.

14. The computer system of claim 12, wherein the operational scope identifies at least one type of infrastructure unit that is accessible to the user.

15. The computer system of claim 14, wherein the type of infrastructure unit corresponds to a host, pod, or super pod.

16. A non-transitory computer-readable medium storing program code, the program code including instructions that are executable by one or more processors of a computer system to perform:
determining a request to propagate at least one database management operation through a first containerized database instance to one or more different containerized database instances, wherein a network scope of the first containerized database instance is configured to allow database management operations to be propagated to at least a second containerized database instance;
determining that the request satisfies at least one access control restriction to perform the at least one database management operation;
determining that the request to perform the at least one database management operation is permitted to be propagated to the second containerized database instance based at least in part on the network scope configured for the first containerized database instance; and
in response to determining that (i) the request satisfies the at least one access control restriction to perform the at least one database management operation and (ii) that the request to propagate the at least one database management operation through the first containerized database instance to the second containerized database instance is permitted, providing the at least one database management operation to the first containerized database instance for execution, wherein the at least one database management operation is propagated for execution on at least the second containerized database instance.

17. The non-transitory computer-readable medium of claim 16, wherein determining that the request satisfies at least one access control restriction causes the one or more processors to perform:
determining that a user that provided the request is associated with a role and operational scope required to execute the at least one database management operation.

18. The non-transitory computer-readable medium of claim 17, wherein the role identifies the user as an administrator, an operator, or a viewer.

19. The non-transitory computer-readable medium of claim 17, wherein the operational scope identifies at least one type of infrastructure unit that is accessible to the user.

20. The non-transitory computer-readable medium of claim 19, wherein the type of infrastructure unit corresponds to a host, pod, or super pod.
